(19) United States
(12) Patent Application Publication
(10) Pub. No.: US 2015/0094830 A1
(43) Pub. Date: Apr. 2, 2015

(54) Network-based Care System

(71) Applicant: Rest Devices, Inc., Boston, MA (US)

(72) Inventors: Thomas Lipoma, Boston, MA (US); Carson Darling, Boston, MA (US)

(21) Appl. No.: 14/513,636

(22) Filed: Oct. 14, 2014

Related U.S. Application Data
(63) Continuation-in-part of application No. 14/479,957, filed on Sep. 8, 2014.
Application No. 14/479,957 is a continuation-in-part of application No. 13/745,098, filed on Jan. 18, 2013.
(60) Provisional application No. 61/890,405, filed on Oct. 14, 2013.
(60) Provisional application No. 61/875,310, filed on Sep. 9, 2013.
(60) Provisional application No. 61/713,177, filed on Oct. 12, 2012.
(60) Provisional application No. 61/587,838, filed on Jan. 18, 2012.
(60) Provisional application No. 61/890,519, filed on Oct. 14, 2013.
(60) Provisional application No. 61/890,401, filed on Oct. 14, 2013.
(60) Provisional application No. 61/890,380, filed on Oct. 14, 2013.

(51) Int. Cl. G05B 15/02; G06F 19/00

(52) U.S. Cl. CPC G05B 15/02; G06F 19/3475
USPC 700/90

(57) ABSTRACT

A networked computer-based system, method, and computer program product for providing care to an infant is disclosed. First data is received through a first communication path at an event server from a first device. The first device may be a childcare device or the first device may be a user device, such as a user's cellular telephone, networked personal computing device, or a health/sleep monitor. The event server also receives second data from a second device through a second communication path. The first communication path and the second communication path being at least partially different. The second communication device may be childcare device. The event server determines whether to send a control signal to a controllable childcare device or send a control signal to controllable childcare device. The event server uses the first and second data and applies the data to predetermined logic to determine a result. A control signal is sent to the controllable childcare device for changing the state of the childcare device and causing it to assume a different behavior. In the alternative, an alarm message is sent to the personal computing device of a caregiver based upon the result.

### PRIORITY

The present United States patent application is a continuation-in-part of U.S. Ser. No. 14/479,957 filed Sep. 8, 2014 entitled “Method and Apparatus for an Infant-milk Warmer” and, through that application, claims priority from U.S. Provisional Application Ser. No. 61/890,405 filed Oct. 14, 2013 entitled “Method and Apparatus for an Infant-milk Warmer” and U.S. Provisional Ser. No. 61/875,310 filed Sep. 9, 2013 entitled “Method and Apparatus for an Infant-milk Warmer”.

This application is also a continuation-in-part of U.S. Ser. No. 13/745,098 filed Jan. 18, 2013 entitled “System and Method for Measuring Movement of a Body Part” and, through that application, claims priority from U.S. Provisional Application Ser. No. 61/713,177 filed Oct. 12, 2012 entitled “System and Method for Measuring Movement of a Body Part” and U.S. Provisional Ser. No. 61/587,838 filed Jan. 18, 2012 entitled “Device and Method for Measuring Movement of a Body Part”.

This application also claims priority from U.S. Provisional Ser. No. 61/890,519 filed on Oct. 14, 2013 entitled “Network-based Infant Care System,” U.S. Provisional Ser. No. 61/890,401 filed on Oct. 14, 2013 entitled “Network-based Infant Care System” and U.S. Provisional Ser. No. 61/890,380 filed on Oct. 14, 2013 entitled “Infant Sleeping Aid and Infant Crib Accessory.”

All of the above described applications are hereby incorporated herein by reference in their entirety.

### TECHNICAL FIELD

The present invention relates to a care system, and more particularly, to a network-based care system that interfaces to one or more networkable accessories and aids a caregiver in the care of a subject.

### BACKGROUND

Various products are available in the market that helps caregivers in providing care to an infant, particularly in the monitoring of the respiration of the infant (for health conditions, such as apnea), in the feeding of the infant, and in aiding the infant to sleep and/or remain sleep. These devices typically have fixed sets of operations. The devices generally also require initiation or intervention by the caregiver to operate.

### SUMMARY

A networked computer-based system, method, and computer program product for providing care to an infant is disclosed. First data is received through a first communication path at an event server from a first device. The first device may be a childcare device or the first device may be a user device, such as a user's cellular telephone, networked personal computing device, or a health/sleep monitor. The event server also receives second data from a second device through a second communication path. The first communication path and the second communication path being at least partially different. The second communication device may be childcare device. The event server determines whether to send a control signal to a controllable childcare device or send an alert to a care giver. The event server uses the first and second data and applies the data to predetermined logic to determine a result. The predetermined logic may be an algorithm in the form of computer code that uses at least the first and second data as input to determine a next action. The predetermined logic may use various source of data such as data stored in databases directly accessible by the event server, data stored on remote databases associated with another server that are not directly accessible and require requests for access, user preferences stored in a user database (e.g. user preferences may include expected sleep times, length of sleep, number of feedings, environmental conditions etc.) A control signal is sent to the controllable childcare device for changing the state of the childcare device and causing it to assume a different behavior. In the alternative, an alarm message is sent to the personal computing device of a caregiver based upon the result. In some embodiments, both a control signal and a separate alarm are transmitted from the event server.

The first and second data received by the event server may be data indicative of an event i.e. event data. The event data may be based upon sensed data and other data, such as user preferences, historical data, environmental data etc. wherein a processor, such as a category server or a child care device may apply a set of criteria to determine if an actual event has occurred and the category server or child care device passes the event data to the event server. In certain embodiments of the invention, the first and second data may be the first and second data may be biometric data, video data, state information of a childcare device, environmental data, or state information of child development.

In some embodiments of the invention, the first communication path includes one or more servers that process data to determine if an event has occurred based in part upon data received from the first device. Thus, the data originating from the childcare device would not be event data, but the data transmitted from the server to the event server would be event data. These servers may be category servers wherein a category server operates in conjunction with one or more childcare devices and the childcare devices perform a specified function (e.g.health monitoring, feeding monitoring, sleep monitoring etc.).

In other embodiments of the invention, data received from the two devices and processed by the event server may result in a control signal being sent to a different childcare device. Thus, data and events generated by two childcare devices may result in a control signal causing operation of a third childcare device. The control signal that is sent to a child care device may provide an instruction or instruction set to the controllable child care device or the control signal may simply change the state of one or more parameters associated with the child care device.

In certain embodiments of the invention, the first communication path or the second communication path or both include the Internet. Embodiments of the invention may include a second server. This second server communicates with the event server and provides data including event data to the event server. The second server may receive data from a device using a proprietary communication protocol. The second server is in communication with the event server and may transfer data from a childcare device or event data to the event server. The second server may reside within the second communication path. In certain configurations of the invention, the second data is transmitted by the second childcare device to the first childcare device prior to the second data being received by the event server.

The second data that is transmitted by the second childcare device may be transmitted to the event server through a personal computing device. The predetermined logic at the event server may normalize, upsample, downsample, or perform a plurality of functions on the data.

In additional embodiments of the invention, user preferences may be entered into the system and stored at a database that is accessible by the event server. Event data can be generated based upon the user preferences and the event data can be used to determine if an event has occurred.

The disclosed methodology may be implemented on a server by providing a computer program product with software code thereon for performing one or more of the steps of the methodology. In one embodiment, the computer is a server on which the computer program product is installed, which changes the server into an event server.

### BRIEF DESCRIPTION OF THE DRAWINGS

The foregoing features of embodiments will be more readily understood by reference to the following detailed description, taken with reference to the accompanying drawings, in which:

FIG. 1 schematically illustrates an infant care system according to an illustrative embodiment of the invention;

FIG. 1a schematically shows another embodiment of the infant care system wherein the event server may be in communication with a second server that is associated with one or more child care devices or other devices that produce data;

FIG. 2 schematically illustrates a method of decision making by the event server according to an embodiment of the invention;

FIG. 3 schematically illustrates a method of adding data to the information database from a category server according to an embodiment of the invention;

FIG. 4 schematically shows different sources of data being transmitted or requested by an event server for determining if an alert should be transmitted to a device associated with a user or an action should be initiated through a known communication protocol to one or more child care devices

### DETAILED DESCRIPTION OF SPECIFIC EMBODIMENTS

In illustrative embodiments of the invention, a novel control system and methodology for a network-based infant care system is disclosed.

As used in the present disclosure, the terms: caretaker, user, and parent may be used interchangeably unless the context dictates otherwise;

As used in the present disclosure, the term “data” shall mean data from any source, but in particular data that is sensed by a sensor, such as a sensor associated with a child care device, a personal computing device (e.g. GPS information), or a health/sleep monitoring device or state information about one or more parameters of a device (e.g. child care device). Data may be represented as, but is not limited to biometric data, video data, a child-care device state, environmental data, child developmental state, state of care provided to an infant, state of infant care. Data from a source can be used to determine if an “event” has occurred.

As used in the present disclosure, the term “event” shall mean the determination that an action has occurred based upon data from one or more sources. In general, the presence or absence of an event is determined by using received/retrieved data (e.g. data preferences, data sent from a childcare device, data sent from a user's computing device or health monitoring device) and applying the data to a criteria. For example, a childcare device may send data indicative of the movement of an infant and the position of an infant. This data may be used to determine if the infant is awake and thus, an event has occurred. The data is applied to predetermined criteria.

Although embodiments of the invention and directed to care systems directed to infants, the present invention applies to any care system for any person (e.g. infant, child, disabled, elderly) that requires a caretaker/caregiver.

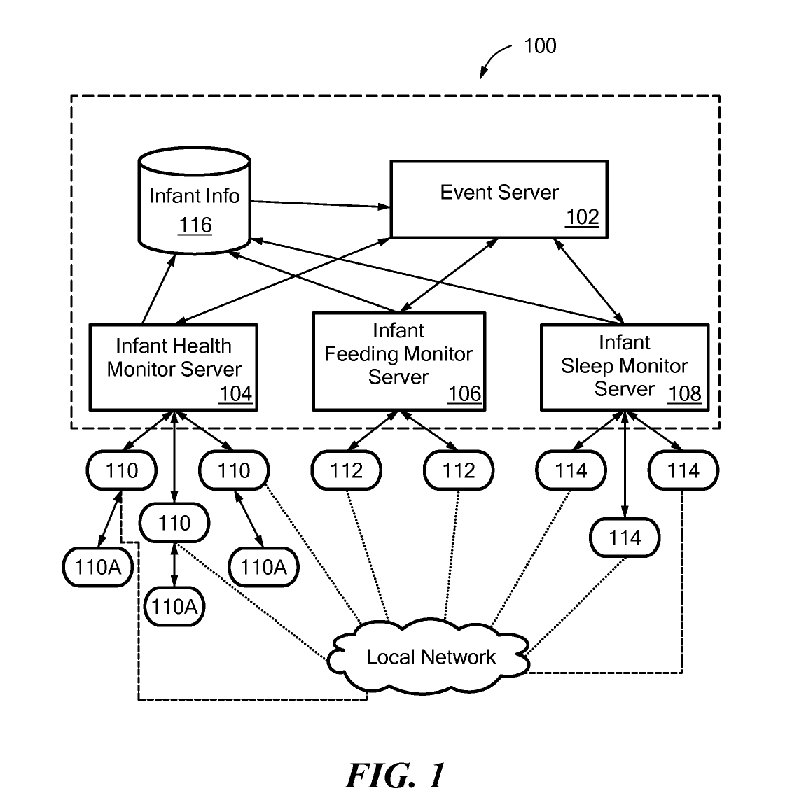

FIG. 1 schematically illustrates an infant-care system 100 according to an illustrative embodiment of the invention. The system 100 preferably includes an event server 102 to negotiate information among category servers associated with an aspect of care for an infant. The category servers may include an infant health-monitoring server 104, an infant-feeding monitoring server 106, and an infant-sleep monitoring server 108.

The category servers 104, 106, 108 preferably aggregate data from each of the respective category devices. It should be understood that each server may be independent and that the servers may be combined together such that the functionality of the event server and at least one of the category servers are performed by a single server system. The servers may also be distributed, such that the event server operates across a plurality of processing devices or there is a plurality of servers of a particular type. For example, there may be more than one event server and more than one category server and these servers may be located at a single facility or at multiple facilities.

The health-monitoring server 104, for example, communicates with a base station 110, which is operatively linked to a health-monitoring controller 110a. In an embodiment, the monitoring controller 110a is a capacitive-based sensing device embedded in an article of clothing of the infant.

The Infant feeding monitor server 106 communicates with an infant feeding-system 112 to assist the caregiver in the feeding of the infant. In an embodiment, the feeding system 112 is a heater and chiller system for regulating temperature of an infant milk or formula. The manner of communication between the servers 104, 106, 108 and the base station 110, the feeding system 112 and the infant-bed accessory 114 may be any known manner of communication between devices including both wired and wireless communications. The devices could be associated with an IP address and communicate over a wireless LAN or through an Internet connection. Similarly, the health-monitoring controller 110a and the base station may communicate either wirelessly or via wire and may be part of a network.

Each communication path as shown in FIG. 1 may be a communication over a different network/system having different associated communication protocols. For example, the communication between the infant health monitor server 104 and the base station may be a proprietary communication link whereas the communication between the infant health monitor server 104 and the event server may be through the Internet using standard IP (Internet Protocol) communications. Additionally, the infant-care system and each of its components may be located either locally (local to the location of a user/infant being monitored) or remote from the location of the infant being monitored. The infant-care system will generally be associated with a plurality of users/infants wherein each user will have one or more monitoring devices 110, 112, and 114 located at their premises and the system can be located at one or more server locations. The components can be operated in a distributed fashion across multiple processing devices and located at different physical and logical locations within one or more networks.

The infant-sleep monitoring server 108 communicates with an infant-bed accessory 114 and assists the caregiver in putting the infant to sleep. In an embodiment, the infant-bed accessory 114 is an infant mobile with configurable lights, sound, and motion output.

Examples of the health monitoring controller 110a and base stations 110 are described in U.S. patent application Ser. No. 13/745,098, and U.S. provisional application, Ser. No. 61/713,177, by Lipoma et al. An example of the feeding system 112 is described in U.S. patent application, Ser. No. 61/875,310, by Lipoma et al. An example of the infant-bed accessory 114 is described in co-pending U.S. provisional application, titled “Infant Sleeping Aid and Infant-Bed Accessory”, filed on Oct. 14, 2013, by Lipoma et al. These applications are incorporated herein by reference in their entireties.

The category servers 104, 106, 108 or the event server 102 may interface to a cellular network to receive signals and data from personal computing devices. These personal computing devices may include, without limitation, a personal phone, a computer, a tablet, or any other suitable electronic device, which is connected to the internet and can display an output.

The system 100 includes an infant information database 116 to store information measured or determined at the base station 110, the feeding system 112, and the infant-bed accessory system 114.

The base station 110 preferably measures physiological states of the infant, including, but not limited to movement, heart rate, breathing rate, body temperature, skin temperature, blood oxygen saturation level, location, noise, moisture level of the infant's garments (such as diapers), and body temperature. The base station 110 may maintain a determined state of the infant from the physiological state information, such as:
Whether the infant is awake;
Whether the infant is asleep;
Whether the infant is irritated;
Whether the infant is crying;
Whether the infant is fussy;
Whether the infant's garment requires changing; and
Mood of the infant.

The infant feeding system 112 preferably measures the time of use information associated with the feeding of the infant as well as the feeding quantity and the environment around the feeding system 112. The feeding system 112 may maintain an expected feeding schedule for the infant.

The infant-bed accessory system 114 assists the caregiver in putting the infant to sleep by providing lulling or calming lights, sounds, or motion. The infant-bed accessory systems 114 preferably measures physiological states of the infant including, but not limited to, whether the infant is awake or sleep. The infant-bed accessory 114 may also measure environmental conditions around the infant, including temperature levels, humidity levels, and noise levels.

The devices 110, 112, 114 may operate in conjunction with the system 100 in helping make better decisions at each of the respective infant care device 110, 112, 114. Preferably, the respective infant care device 110, 112, 114 may be configured to operate independently of one another. However, in using these devices 110, 112, 114 in combination, the collected information of each device is preferably employed in the controls of the other devices to improve the system's assistance of care provided by the caregiver.

As such, when device 110, 112, or 114 collects new information, the device 110, 112, or 114 may send that information to the system 100 or may share them directly with the other devices 110, 112, or 114 across a local network 120. In an embodiment, the device sends that information to the devices category server 104, 106, 108. The category server 104, 106, 108 may then decide whether to provide the information to the infant information database 116. If any of the device category servers 104, 106, 108 generates an event, the category server 104, 106, 108 may send that event to the event server 102. As indicated, the category servers 104, 106, 108 may interface to a cellular network to receive signals and data from the personal computing devices. It should be understood that other networking and communications may be employed with changing the scope of the invention and the invention is not limited to cellular networks. The category servers 104, 106, 108 may receive preferences and information from the personal computing device to generate an event. Alternatively, the event server 102 may receive the preferences and information directly, and it may generate them as a subsequent event to process.

With each event received, the event server 102 may send an alert to a caregiver or perform some action. For example, an alert may be communicated from the event server to a text messaging address, an e-mail address, to a telephone number (cellular/landline) or via other known communication systems. An action may include relaying the event to the other devices 110, 112, and/or 114. To do so, the event server 102 may send the alert through the category servers 104, 106, 108. The action may also include initiating a process to determine whether to send commands to respective devices 110, 112, 114.

In an embodiment, during operation, a health monitoring device 110 collects data associated with the infant and sends the data to the health-monitoring server 104. Assume, for example, that the health-monitoring server 104 decides that the data indicates that the infant has woken up—the server 104 then sends an event to the event server 102. The event server 102 would then decide whether to send an alert to a personal computer device, such as the caregiver's mobile phone. The event server 102 may then interrogate the database 116 for other states of the infant, such as whether the infant is hungry. Assume, for example, that such information is in the database 116; the event server 102 may then send an event back down the infant-feeding monitoring server 106, which then sends the event to the feeding system 112. The event may include a command to initiate a control state for the temperature controls of the feeding system 112.

FIG. 1A schematically shows an alternative embodiment of the infant care system. In this embodiment, the infant care system of FIG. 1 may include a plurality of servers. As shown, the system includes a system server 150 that may perform the functions of the event server (102) and one or more of the category servers (104, 106, 108) of FIG. 1. The system server 150 may include one or more databases, including an infant data database, a user preferences database, and a database that maintains historical information. Historical information may be a compilation of data from the plurality of users/child care devices that are coupled to the childcare system.

Additionally, a second server 160 may be part of the system 100 or in communication with the system 100 and this second server 160 receives in information from networked devices (i.e. child care devices 167, personal computing devices 165, and/or health/sleep monitoring devices 169). The second server 160 may operate independently of the system server 150 and of the childcare system. For example, the second server 160 may have proprietary communications with one or more childcare devices. However, the second server 160 can provide information received through these proprietary communications to the system server 150 and this information can be used in determining a next action or whether an alert should be sent to a caregiver. This second server 160 may be in communication 180 with the system server 150 and cause alerts to be passed either directly back to a user's personal computer device 165 or to one or more of the child care devices 167. These alerts may be generated based upon information communicated to the system serve 150r.

The system server 150 may simply pass data from child care devices 167 to the second server 160 or the system server 150 may provide the second server 160 with additional data (statistics, personal data about the user or infant, indication of the occurrence of an event, historical data) and/or an algorithm for determining whether an alert or message (e.g. a control signal for the child care device) should be passed to a user's communication device or to one or more of the child care devices. Additionally, the system server 150 may pass the alert to the second server 160 and the second server may communicate with one or more of the childcare devices 167. Thus, not all of the childcare devices 167 need to communicate directly with the system server 150. Devices from different product categories (or even different companies) can work independently, but then have their respective server (such as the second server or another server) transmit data to other servers such that the system server 150 could aggregate data from different sources (child care devices, health/sleep monitor devices) and determine based upon a predetermined algorithm using the aggregated data whether an alert or other message should be sent to a personal computing device or to a child care device.

For example, as shown in FIG. 1A an audio monitor 175 may have a one-way communication to a webserver 170. The audio monitor 175 functions independently and would have no way of interacting with the system server 150 or with any other childcare devices 167 that communicate directly with the system server 150. However, since the server 170 that the audio monitor communicates with can then send data or events to the system server 150 over a communication path 180, the data received from the audio monitor may be used in combination with other data received from one or more child care devices for determining whether to generate separate events/alerts/data/actions

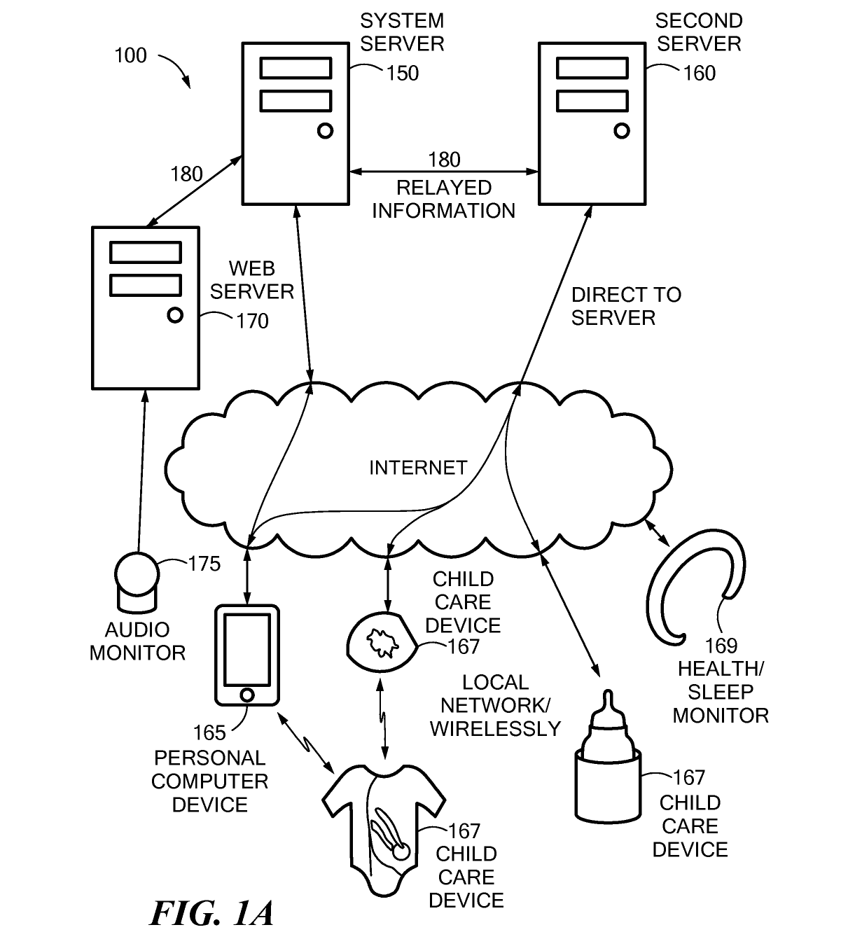

The operation of the event server 102 is now described in further detail. FIG. 2 schematically illustrates a method of decision making by the event server 102. The event server 102 first checks (in state 202) for new events. The event server 102 then determines (in state 204) if there is a new event. If there is a new event, the event server 102 reads (in state 206) data from the information database 116. The data from the information database 116 may include permission and/or preferences to send a notification to the personal computing device as well as and a trigger to initiate a process associated with the event. The data from the information database 116 may include information about a user such as the sleep state of the user. The event server 102 then determines (in state 208) if the user should be notified. If permission is provided, the event server 102 sends (in state 210) an alert to the personal computing device. The event server 102 then checks (in state 212) whether the event should be sent to the device 110, 112, or 114. If the alert should be sent to the device 110, 112, 114, then the event server 102 sends (in state 214) the alert and checks (in state 202) for new events. An alert may refer to a notification, a message, a report, and any trigger to inform a user of some information.

The event server 102 may receive events from feeding systems 112, sleeping-aid systems 114, monitoring systems 110, or the category servers 104, 106, 108. The event server 102 may also receive events from the personal computing device or from its own internally generated processes.

Table 1 shows examples of events that may be initiated by the infant care devices 104, 106, or 108. The table lists the event, the source of the event, the action to determine whether to send as alert, and other actions associated with the event.

As shown in the table, upon an event indicating the infant is awake (event 1), is asleep (event 2), is hungry (event 3), is irritated (event 4), is moody (event 5), is fussy (event 6), or is crying (event 7), the event server 102 pulls stored notification preferences of the caregiver of the respective event and sends out an alert where the permission is given.

Event 1 may cause several actions by the event server 102. For example, the event server 102 may initiate events to determine whether the infant is hungry (event 3), is irritated (event 4), is moody (event 5), is fussy (event 6), is or crying (event 7). Subsequently, depending on the determined state of the infant (in events 3, 4, 5, 6, and/or 7), the event server 102 may (i) do nothing, (ii) send information/commands to the feeling-system 112 to initiate a temperature control action or (iii) send information/commands to the sleeping-aid system 114 to initiate a lulling sequence to calm the infant back to sleep.

Event 2 indicates that the infant is asleep. The event server 102 pulls stored notification preferences of the caregiver of this event and sends out an alert where the permission is given. The event server 102 may determine the source of the event and relay the information to the other devices.

TABLE 1

| | Event | Source | Send Alert | Action |
|---|---|---|---|---|
| 1 | Infant is | monitoring | Pull notification | Pull condition to |
| | awake | system 110; | preference of the | determine whether the |
| | | feeding system | user | infant is hungry, |
| | | 112; or | | irritated, moody, fussy, |
| | | sleeping-aid | | or crying |
| | | system 114 | | |
| 2 | Infant is | monitoring | Pull notification | If from monitoring |
| | asleep | system 110 or | preference of the | system 110, send event |
| | | sleeping-aid | user | to the sleeping-aid |
| | | system 114 | | system 114; if from |
| | | | | sleeping-aid system |
| | | | | 114, send the event to |
| | | | | the feeding system 112 |
| 3 | Infant is | feeding system | Pull notification | Send information to the |
| | hungry | 112 or | preference of the | sleeping-aid system 114 |
| | | monitoring | user | |
| | | system 110 | | |
| 4 | Infant is | monitoring | Pull notification | Send information to the |
| | irritated | system 110 or | preference of the | sleeping-aid system |
| | | from the event | user | 114; send information |
| | | server 102 | | to the feeding system |
| | | | | 112 |
| 5 | Infant is | monitoring | Pull notification | Send information to the |
| | moody | system 110 or | preference of the | sleeping-aid system |
| | | from the event | user | 114; send information |
| | | server 102 | | to the feeding system |
| | | | | 112 |
| 6 | Infant is | monitoring | Pull notification | Send information to the |
| | fussy | system 110 or | preference of the | sleeping-aid system |
| | | from the event | user | 114; send information |
| | | server 102 | | to the feeding system |
| | | | | 112 |
| 7 | Infant is | monitoring | Pull notification | Send information to the |
| | crying | system 110 or | preference of the | sleeping-aid system |
| | | the sleeping- | user | 114; send information |
| | | aid system 114 | | to the feeding system |
| | | | | 112 |

Table 2 shows events preferably generated by the event server 102. Events 8 and 9, for example, indicate that a sleep schedule or a feeding schedule, respectively provided by the caregiver has met a specific condition, such as time.

The event server 102 or the respective category servers 104, 106, 108 may monitor for specific conditions that the caregiver has selected. In event 10, the event server 102 may send a command to the sleeping-aid system 114 to turn on when infant is determined to be awake, is not hungry, and is not irritated. In event 11, the event server 102 may send commands to initiate temperature control of the feeding system 112 upon the infant being determined to be hungry and that the personal computer device associated with the user is in a specified proximity to the feeding system 112.

In events 12 and 13, the event server 102 may provide notification to the personal computing device upon new recommendations for the sleeping time or the feeding being determined.

TABLE 2

| | Event | Source | Send Alert? | Action |
|---|---|---|---|---|
| 8 | Sleep schedule | event server | Pull notification | Depending on the |
| | meets | 102 | preference of the | preferences, send |
| | specified | | user | command to |
| | condition | | | initiate the |
| | | | | sleeping-aid |
| | | | | system 112 |
| 9 | Feeding | event server | Pull notification | Depending on the |
| | schedule | 102 | preference of the | preferences, send |
| | meet specified | | user | command to |
| | condition | | | initiate the |
| | | | | feeding system 112 |
| 10 | Condition: | event server | Pull notification | Depending on |
| | Infant | 102 | preference of the | preferences, send |
| | is awake + not | | user | command to the |
| | hungry + not | | | sleeping-aid |
| | irritated | | | system 114 |
| | | | | to initiate output |
| 11 | Condition: | event server | Pull notification | Depending on the |
| | Infant | 102 | preference of the | preferences, send |
| | is hungry and | | user | command to |
| | personal | | | the feeding |
| | computing | | | system 112 |
| | device | | | |
| | is in proximity | | | |
| 12 | New | event server | Pull notification | |
| | recommended | 102 or | preference of the | |
| | feeding setting | feeding | user | |
| | found | system 112 | | |
| 13 | New | event server | Pull notification | |
| | recommended | 102 or | preference of the | |
| | sleeping setting | sleeping-aid | user | |
| | found | system 114 | | |

Table 3 shows events preferably generated by the personal computing device. In events 14-16, the event server 102 receives feeding or lulling instructions as preferences from the caregiver. The event server 102 may relay the information to the respective care device (112, 114) (such as in event 14), or it may initiate a process to monitor for such conditions (events 15 and 16). The monitoring process may generate subsequent events, such as events 8 or 9.

In event 17, the personal computing device may generate an event to indicate to the various system of the proximity of the caregiver. The event server 102 may relay the information to the respective care device 112 or 114.

In event 18, the personal computing device may generate an event to indicate a remote-talking session with the infant. To this end, the event server 102 may send the information to the sleeping-aid system 114 to disable the activating of the sound or lights output and not disturb the talking session.

Events 19-21 are a house-cleaning operations in which the event server 102 updates the notification preferences upon a preference being received (event 19) or updates the information database 116 with a respective device ID (event 20 or 21).

TABLE 3

| | Event | Source | Send Alert? | Action |
|---|---|---|---|---|
| 14 | Receive feeding | personal | | Send information |
| | information | computing | | to the feeding |
| | | device | | system 112. |
| 15 | Receive feeding | personal | | Send information |
| | schedule | computing | | to the |
| | | device | | feeding system 112; |
| | | | | add as a condition |
| 16 | Receive lulling | personal | | Send information to |
| | schedule | computing | | the sleeping-aid |
| | | device | | system 114; add as |
| | | | | a condition |
| 17 | User in proximity | personal | | Send information |
| | | computing | | to the |
| | | device | | sleeping-aid system |
| | | | | 114; send information |
| | | | | to the feeding |
| | | | | system 112. |
| 18 | User initiate | personal | | Send information |
| | remote-talking | computing | | to the sleeping-aid |
| | session with the | device | | system 114 |
| | infant | | | |
| 19 | Receive | personal | | Update notification |
| | preference | computing | | preference |
| | information | device | | |
| 20 | Receive | Feeding | | Update notification |
| | association of | system | | preference; enable |
| | feeding system to | | | hunger monitor. |
| | the infant ID | | | |
| 21 | Receive | sleeping-aid | | Update notification |
| | association of | system | | preference; |
| | sleeping-aid | | | enable sleep |
| | system to the | | | monitor |
| | infant ID | | | |

Table 4 shows events preferably generated by the monitoring system 110. In events 22-24, the event server 102 pulls notification preferences of the user to determine whether to alert the user of a measured state of the infant, including abnormal breathing rate (event 22), abnormal temperature (event 23), or unsafe conditions (event 24).

TABLE 4

| | Event | Source | Send Alert? | Action |
|---|---|---|---|---|
| 22 | Breathing rate is | monitoring | Pull notification | |
| | below threshold | system 110 | preference of the | |
| | | | user | |
| 23 | Skin temperature | monitoring | Pull notification | |
| | level is above | system 110 | preference of the | |
| | threshold | | user | |
| 24 | Infant is oriented | monitoring | Pull notification | |
| | on stomach | system 110 | preference of the | |
| | | | user | |

It should be appreciated that the various events described above are merely illustrative.

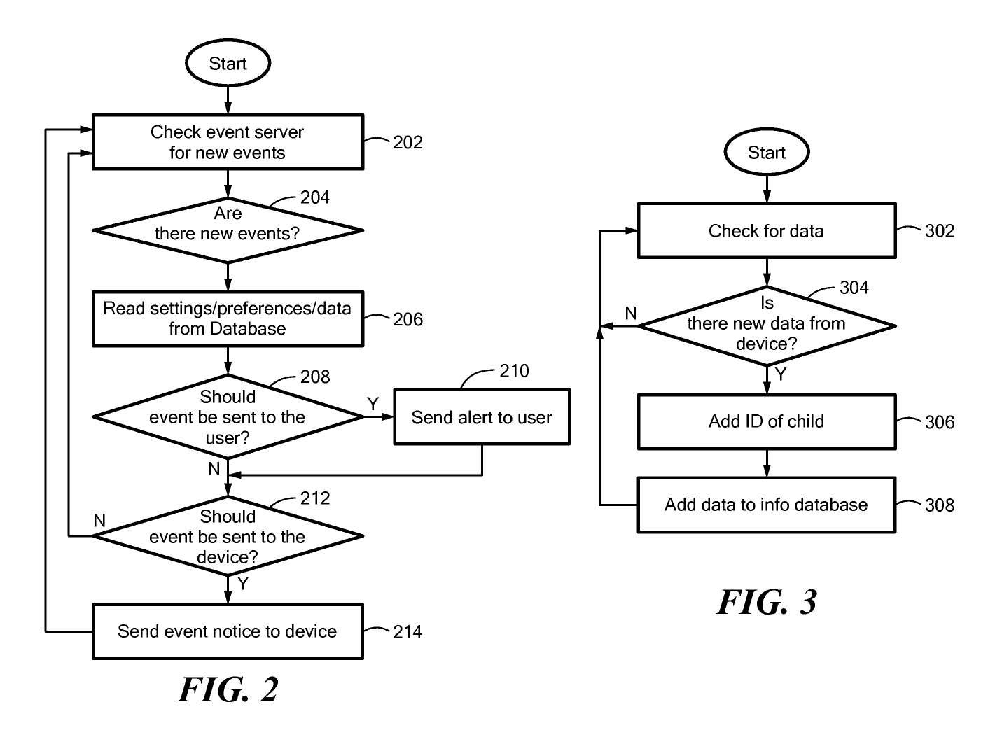

FIG. 3 schematically illustrates a method of adding data to the information database 116 from a category server 104, 106, or 108. The server 104, 106, or 108 first checks (in state 302) for data. The server 104, 106, or 108 determines (in state 304) if the data is new by comparing the received data to entries in the information database 116. A buffer may be maintained of recently retrieved information from the database 116. The category server 104, 106, 108 then checks (in state 306) for the infant ID number and associates the information to the infant. As such, the infant information database maintains an infant ID identifier with each event or data. The category server 104, 106, 108 then adds (in state 308) the information into the infant information database 112.

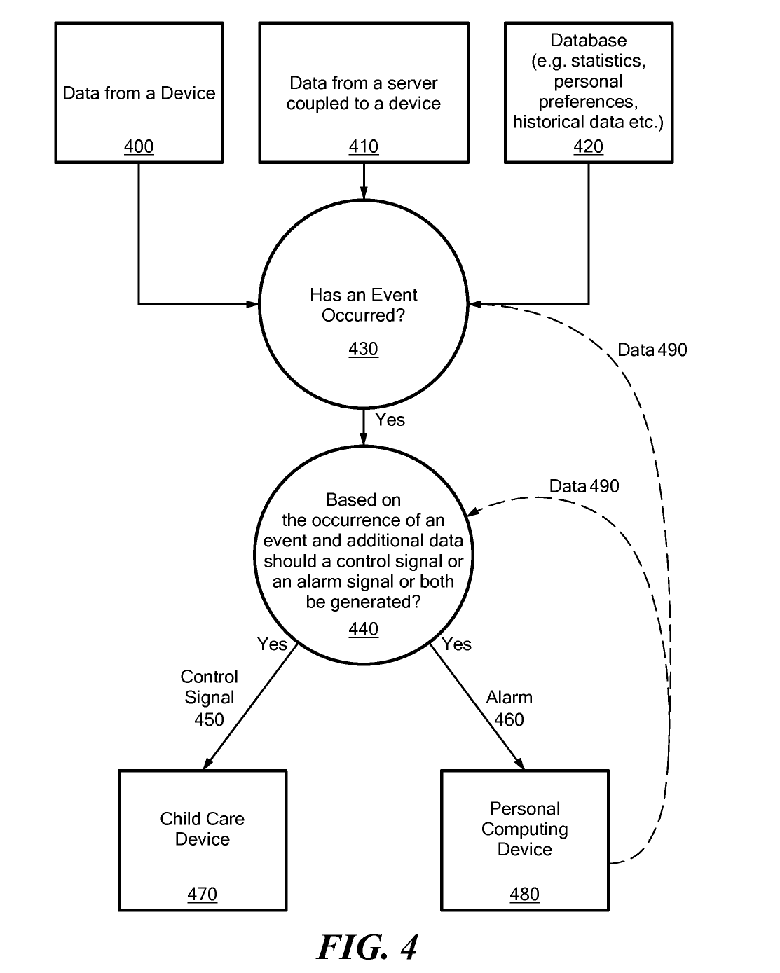

FIG. 4 represents the confluence of data within the childcare system from a plurality of sources including childcare devices 400, and health/sleep monitoring devices, data about a device retrieved or sent from a server 410, and data that is retrieved or sent from a database 420. There may be one or more databases within the system and the databases may hold user preference information, statistics about one or more of the infant's being monitored, historical data that can be used to show trends in a population of infants. Etc. This data is used to decide whether an event is generated 430. The event may be generated based on an algorithm using the data and the event can be generated at the childcare device, at a category server or within the event server/system server. Based on one or more events the event server/system server will determine whether an alarm or control signal is generated and sent from the event server 440. The alarms 460 are sent to a personal computing device 480 and control signals 450 are sent to a childcare device 470. Data can be generated by a childcare device 400, sensor 400A, or other device that includes a sensor and the data can be provided either directly or indirectly to the event server. Data 490 may also be generated by a device such as a caretaker's personal computing device 480 or from the computing device of someone else associated with the infant (e.g. a parent, babysitter, nurse, doctor, nutritionist, pharmacist etc.). For example, a caretaker may have an associated health/sleep tracking device that stores information about the health/alertness of the caretaker. This information may be sensed by the health/sleep monitoring device and stored at a server (e.g. the health/sleep device server). The server for the health tracker/sleep monitoring device may store the information and make the information available to the event server. The event server may use the information about the sleep state of the caregiver in determining whether an alarm should be sent to the caregiver. The event server may also query a database regarding information that is needed to determine if an event has occurred. This database may include user preferences and may also include historical information about the user/infant or historical information for all users/infants or a subset of all users/infants that are associated with the system. User preferences can be stored locally at the event server or on a different server in a database. It should be clear to one of ordinary skill in the art that data from different sources may originate from different locations, but the data will eventually arrive at and be used by the event server in the determination of whether an event has occurred and whether an alert or a control signal should be generated and sent to a child care device.

As one possible example, a networked baby monitor may detect that a baby has woken up based upon the sensed movement of the baby or based upon increased vital signs and can then send this information along with the parents' data and alert preferences to the event server. In other embodiments, the alert preferences and user data (alertness of the caregiver/parent(s)) may be stored on a remote server in a database. In this scenario, the event server could poll the remote database to get the parents sleep data to determine how asleep each parent are, and the event server can then send an alarm to an awake parent rather than sending an alarm to both parents. Thus, data used by the event server may originate from childcare devices, received from a database (e.g. a user preference database), received from a server (health/sleep information of a parent/caregiver) or received directly from a device wherein data from device is directly transmitted to the server.

The embodiments of the invention described above are intended to be merely exemplary; numerous variations and modifications will be apparent to those skilled in the art. All such variations and modifications are intended to be within the scope of the present invention as defined in any appended claims.

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions. Single-ended arrows generally indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

It should be noted that headings are used above for convenience and are not to be construed as limiting the present invention in any way.

A device may include, without limitation, a bridge, router, bridge-router (brouter), switch, node, server, computer, appliance, or other type of device. Such devices typically include one or more network interfaces for communicating over a communication network and a processor (e.g., a microprocessor with memory and other peripherals and/or application-specific hardware) configured accordingly to perform device functions. Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium. Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message. Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

Importantly, it should be noted that embodiments of the present invention may employ conventional components such as conventional computers (e.g., off-the-shelf PCs, mainframes, microprocessors), conventional programmable logic devices (e.g., off-the shelf FPGAs or PLDs), or conventional hardware components (e.g., off-the-shelf ASICs or discrete hardware components) which, when programmed or configured to perform the non-conventional methods described herein, produce non-conventional devices or systems. Thus, there is nothing conventional about the inventions described herein because even when embodiments are implemented using conventional components, the resulting devices and systems (e.g., the childcare devices, system server and event server described herein) are necessarily non-conventional because, absent special programming or configuration, the conventional components do not inherently perform the described non-conventional methods.

We claim:

1. A networked computer-based method for providing care to an infant, the method comprising:
receiving through a first communication path first data from a first childcare device at an event server;
receiving through a second communication path second data from a second child care device at the event server;
determining at the event server whether to send a control signal to a controllable child care device wherein the controllable child care device may include either or both the first or the second child care devices, by applying at least the first data and the second data to predetermined logic to determine a result; and
sending the control signal to the controllable childcare device if the result of the predetermined logic indicates that the control signal should be sent.

2. A networked computer-based method according to claim 1, wherein the first and second data are event data.

3. A networked computer-based method according to claim 1, wherein the first communication path includes one or more servers that process data to determine if an event has occurred and if an event has occurred the first data received by the event server includes data indicative of the event.

4. A networked computer-based method according to claim 3, wherein the one or more servers includes a category server.

5. A networked computer-based method according to claim 1, wherein the controllable childcare device is a third childcare device.

6. A networked computer-based method according to claim 1, wherein the control signal changes the state of the controllable childcare device.

7. A networked computer-based method according to claim 1, wherein the predetermined logic is based in part upon one or more user preferences.

8. A networked computer-based method according to claim 1, wherein the first and second data may be biometric data, video data, state information of a child care device, environmental data, or state information of child development.

9. A networked computer-based method according to claim 1, wherein the first communication path and the second communication path include at least the Internet.

10. A method according to claim 1, wherein the second communication path includes a control server.

11. A networked computer-based method according to claim 1, wherein the second data is transmitted by the second child care device to the first child care device prior to the second data being received by the event server.

12. A networked computer-based method according to claim 1, wherein the second data is transmitted by the second childcare device through a personal computing device.

13. A networked computer-based method according to claim 1, wherein the predetermined logic alters at least the first or second data by normalizing the data, upsampling the data, or downsampling the data or a combination thereof.

14. A networked computer-based method according to claim 6, further comprising:
receiving user preferences at the event server; and
generating one or more events based at least upon the user preferences for use by the predetermined logic.

15. A networked computer-based method for providing care to a child, the method comprising:
receiving through a first communication path first data from a first childcare device associated with the child at an event server;
receiving through a second communication path second data from a second childcare device associated with the child at the event server;
determining whether to send an alert signal to a personal computing device of a caretaker of the child based by applying at least the first data and the second data to predetermined logic to determine a result; and
sending an alert to the personal computing device of the caretaker if the result of the predetermined logic indicates that the alarm should be sent.

16. A networked computer-based method according to claim 1, wherein the first and second data are event data.

17. A networked computer-based method according to claim 15, wherein the first communication path includes one or more servers that process data to determine if an event has occurred and if an event has occurred the first data received by the event server includes data indicative of the event.

18. A networked computer-based method according to claim 17, wherein the one or more servers includes a category server.

19. A networked computer-based method according to claim 15, wherein the predetermined logic is based in part upon one or more user preferences.

20. A networked computer-based method according to claim 15, wherein the first and second data may be biometric data, video data, state information of a child care device, environmental data, or state information of child development.

21. A networked computer-based method according to claim 15, wherein the first communication path and the second communication path include at least the Internet.

22. A method according to claim 15, wherein the second communication path includes a second server.

23. A networked computer-based method according to claim 15, wherein the second data is transmitted by the second child care device to the first child care device prior to the second data being received by the event server.

24. A networked computer-based method according to claim 15, wherein the second data is transmitted by the second childcare device through a personal computing device.

25. A networked computer-based method according to claim 15, wherein the predetermined logic alters at least the first or second data by normalizing the data, upsampling the data, or downsampling the data or a combination thereof.

26. A networked computer-based method according to claim 19, further comprising:
receiving user preferences at the event server; and
generating one or more events based at least upon the user preferences for use by the predetermined logic.

27. A computer program product for use with a computer, the computer program product containing computer program code for networked control of a plurality of childcare devices, the computer program code comprising:
computer code for receiving through a first communication path first data from a first childcare device;
computer code for receiving through a second communication path second data from a second child care device;
computer code for determining whether to send a control signal to a controllable child care device wherein the controllable child care device may include either or both the first or the second child care devices, by applying at least the first data and the second data to predetermined logic to determine a result; and
computer code for sending the control signal to the controllable childcare device if the result of the predetermined logic indicates that the control signal should be sent.

28. A computer program product according to claim 27, wherein the first and second data are event data.

29. A computer program product according to claim 27, wherein the controllable childcare device is a third childcare device.

30. A computer program product according to claim 27, wherein the control signal changes the state of the controllable childcare device.

31. computer program product according to claim 27, wherein the predetermined logic is based in part upon one or more user preferences.

32. A computer program product according to claim 27, wherein the first and second data may be biometric data, video data, state information of a child care device, environmental data, or state information of child development.

33. A computer program product according to claim 27, wherein the first communication path and the second communication path include at least the Internet.

34. A computer program product according to claim 27, wherein the second communication path includes a control server.

35. A computer program product according to claim 27, wherein the predetermined logic alters at least the first or second data by normalizing the data, upsampling the data, or downsampling the data or a combination thereof.

36. A computer program product according to claim 27, further comprising:
computer code for receiving user preferences; and
computer code for generating one or more events based at least upon the user preferences for use by the predetermined logic.

37. A computer program product for use with a computer, the computer program product containing computer program code for networked control of a plurality of childcare devices, the computer program code comprising:
computer code for receiving through a first communication path first data from a first childcare device associated with the child;
computer code for receiving through a second communication path second data from a second childcare device associated with the child;
computer code for determining whether to send an alert signal to a personal computing device of a caretaker of the child by applying at least the first data and the second data to predetermined logic to determine a result; and
computer code for sending an alert to the personal computing device of the caretaker if the result of the predetermined logic indicates that the alarm should be sent.

38. A computer program product according to claim 37, wherein the first and second data are event data.

39. A computer program product according to claim 37, wherein the predetermined logic is based in part upon one or more user preferences.

40. A computer program product according to claim 37, wherein the first and second data may be biometric data, video data, state information of a child care device, environmental data, or state information of child development.

41. A computer program product according to claim 37, wherein the first communication path and the second communication path include at least the Internet.

42. A computer program product according to claim 37, further comprising:
computer code for receiving user preferences at the event server; and
computer code for generating one or more events based at least upon the user preferences for use by the predetermined logic.
